(19) United States
(12) Patent Application Publication
(10) Pub. No.: US 2025/0205917 A1
(43) Pub. Date: Jun. 26, 2025

(54) FOOD PRODUCT SLICER AND ASSOCIATED KNIFE ASSEMBLY

(71) Applicant: ILLINOIS TOOL WORKS INC., Glenview, IL (US)

(72) Inventors: Matthew W. BIRD, Xenia, OH (US); Austin RUTLEDGE, TROY, OH (US)

(21) Appl. No.: 18/929,017

(22) Filed: Oct. 28, 2024

Related U.S. Application Data
(60) Provisional application No. 63/612,814, filed on Dec. 20, 2023.

(51) Int. Cl. B26D 7/26; B26D 7/06; B26D 7/12

(52) U.S. Cl. CPC B26D 7/2621; B26D 7/0616; B26D 7/12; B26D 2210/02

(57) ABSTRACT

A food product slicer includes a base, a knife mounted for rotation about an axis relative to the base via a knife drive shaft, and a knife cover plate overlying regions of the knife. A monolithic mount part is provided that defines a first mount portion to which the knife drive shaft for the knife is mounted and a second mount portion to which the knife cover plate mounts, so as to establish a relative axial position between the knife and the knife cover plate.

### TECHNICAL FIELD

This application relates generally to food product slicers of the type commonly used to slice bulk food products and, more specifically, to a food product slicer with a rotatable slicer knife and associated knife cover.

### BACKGROUND

Typical reciprocating food slicers have a rotatable, circular or disc-like slicing blade, an adjustable gauge plate for determining the thickness of the slice and a carriage for supporting the food as it is moved back and forth past the cutting edge of the knife, and over a knife cover plate, during slicing. A drive motor may be linked to drive the carriage back and forth during an automatic slicing operation carried out by a controller of the slicer and/or manual operation is possible. The gauge plate is situated along the edge of the knife toward the front of a slicing stroke and is laterally movable with respect to the knife for determining the thickness of the slices to be cut. A rotatable adjustment or indexing knob is provided for manually setting a spacing between the plane of the gauge plate surface and the plane of the knife edge for the purpose of slicing so that operators can select a thickness of slices to be produced.

Such existing slicers must hold a tight tolerance between the knife edge and the knife cover plate in order to achieve good slice quality. If the knife cover plate is too high/low compared to the knife, the knife cover plate will tend to rip/tear product slices or prevent the machine from being able to slice very thin. Typically, there are several parts between the knife and the knife cover plate resulting in a large tolerance stack-up, and the knife cover plate is typically mounted on a ring guard. In order to maintain appropriate slice quality with this large tolerance stack-up, slicers historically have allowed for some ring guard adjustment. This is a relatively fine adjustment to ensure proper slicing function. Machines that do not allow for this adjustment typically suffer from poor slicer performance.

It would be desirable to provide a slicer with effective slicing performance without requiring the fine adjustment of the ring guard.

### SUMMARY

In one aspect, a food product slicer includes a base, a knife mounted for rotation about an axis relative to the base via a knife drive shaft, and a knife cover plate overlying regions of the knife. A monolithic mount part is provided that defines a first mount portion to which the knife drive shaft for the knife is mounted and a second mount portion to which the knife cover plate mounts, so as to establish a relative axial position between the knife and the knife cover plate.

In another aspect, a food product slicer includes a base, a knife mounted for rotation about an axis relative to the base via a knife drive shaft, a knife cover plate overlying regions of the knife, a carriage assembly mounted to the base for reciprocal movement back and forth past a cutting edge of the knife, and a gauge plate mounted for movement between a closed position that prevents slicing and multiple open positions that permit slicing at respective thicknesses. A monolithic mount part is provided that defines a first mount portion to which the knife drive shaft for the knife is mounted and a second mount portion to which the knife cover plate mounts, so as to establish a relative axial position between the knife and the knife cover plate.

In yet another aspect, a food product slicer includes a base, a knife mounted for rotation about an axis relative to the base via a knife drive shaft, and a knife cover plate overlying regions of the knife. A monolithic mount part defines a first mount portion to which the knife drive shaft for the knife is mounted, a second mount portion to which the knife cover plate mounts and a third mount portion that defines a sharpener mount station.

### BRIEF DESCRIPTION OF DRAWINGS

FIGS. 1-4 show perspective views of a food product slicer;

FIG. 5 shows a perspective view of the slicer base upper housing;

FIGS. 6-7 show perspective views of interior portions of the base showing the slicer knife drive;

FIGS. 8A-8D and 10 show perspective views of a knife assembly and associated knife drive of the food product slicer, where FIGS. 8C-8D show components exploded away from each other;

FIGS. 9A-9B show perspective views of a monolithic mount part of the knife assembly;

FIGS. 11A-11E show perspective views of portion of a sharpener assembly;

FIG. 12 shows a cross-section of knife mounting on the slicer housing;

FIG. 13 shows a cross-section of the sharpener assembly; and

FIG. 14 shows a cross-section of a securing knob for the knife cover plate.

### DETAILED DESCRIPTION

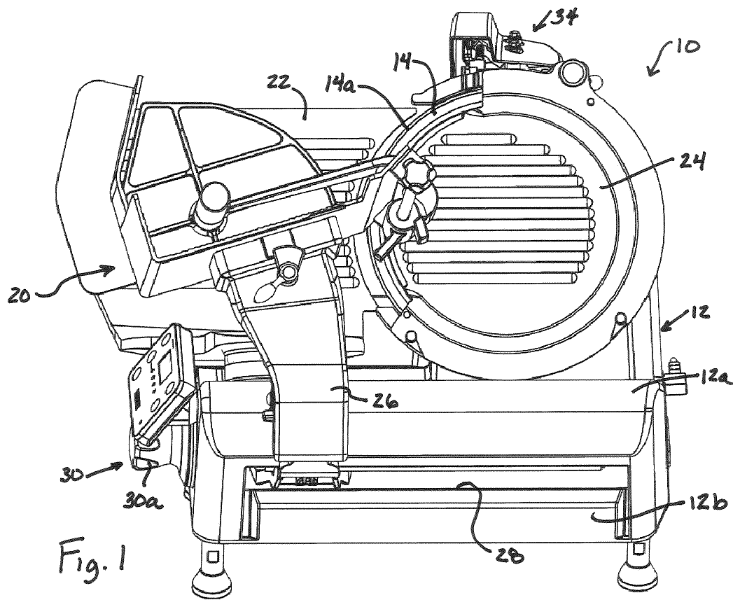

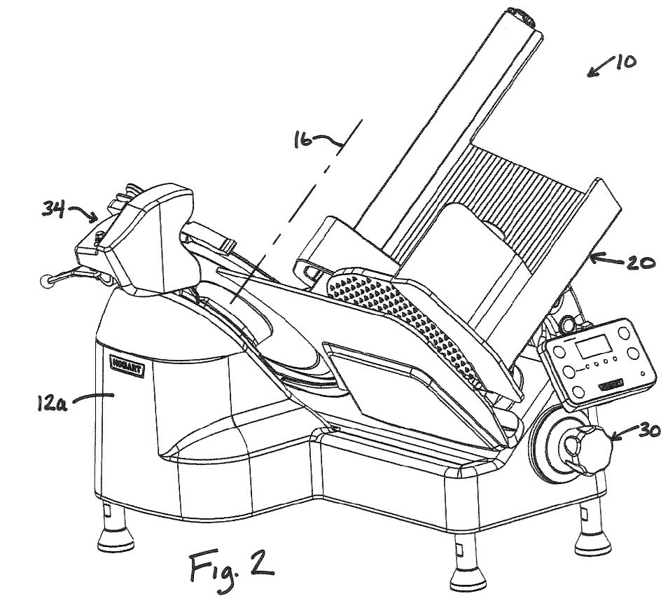

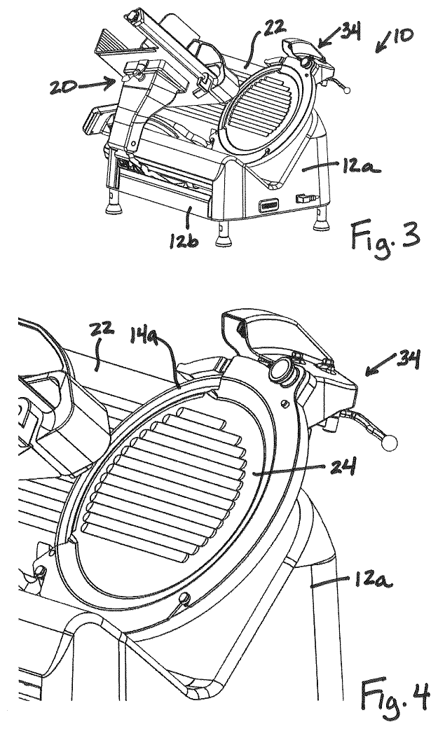

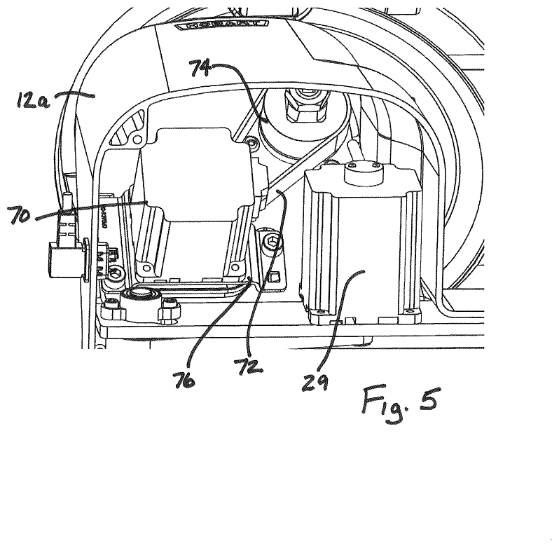

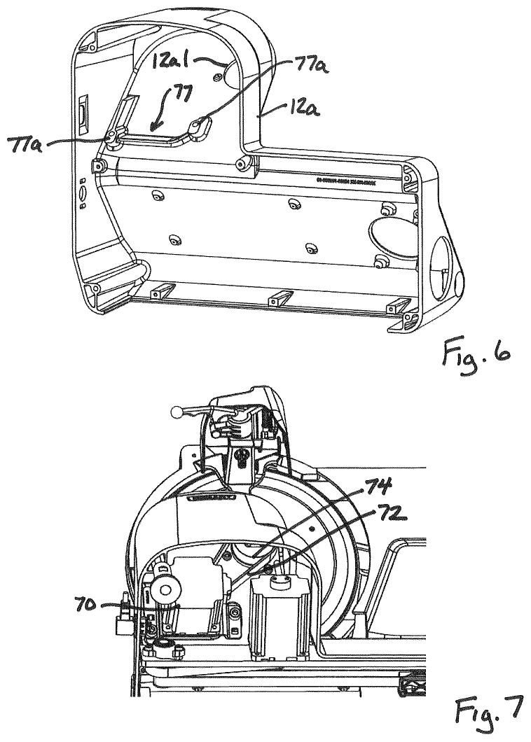

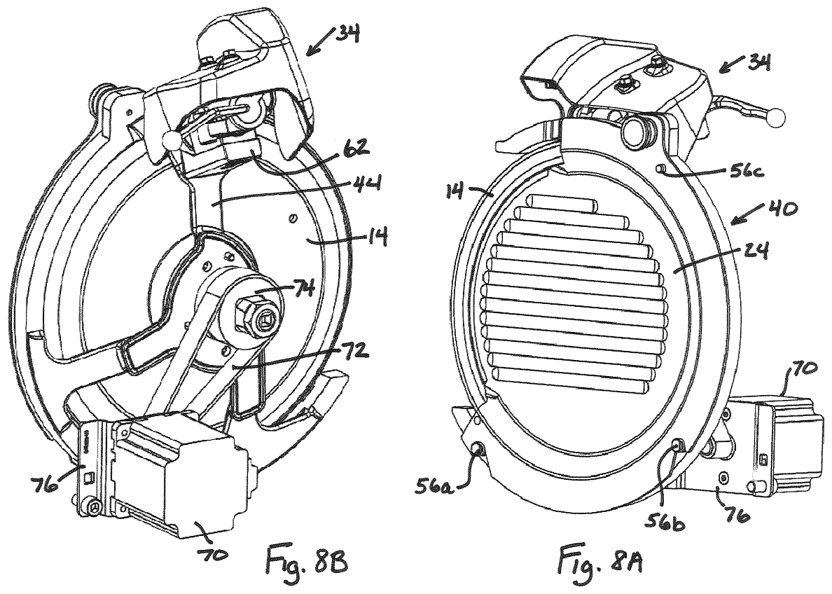

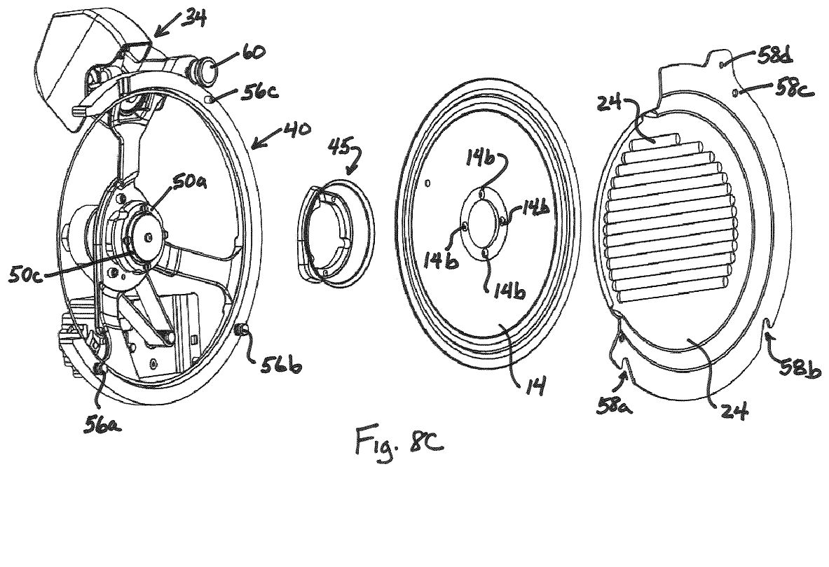

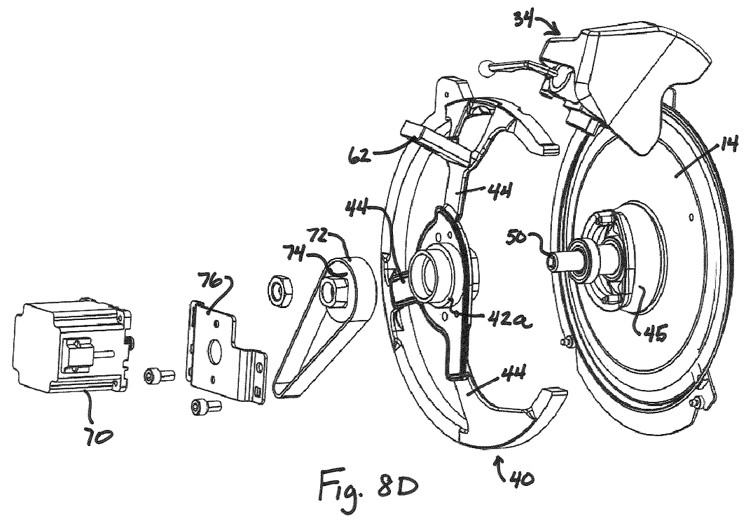

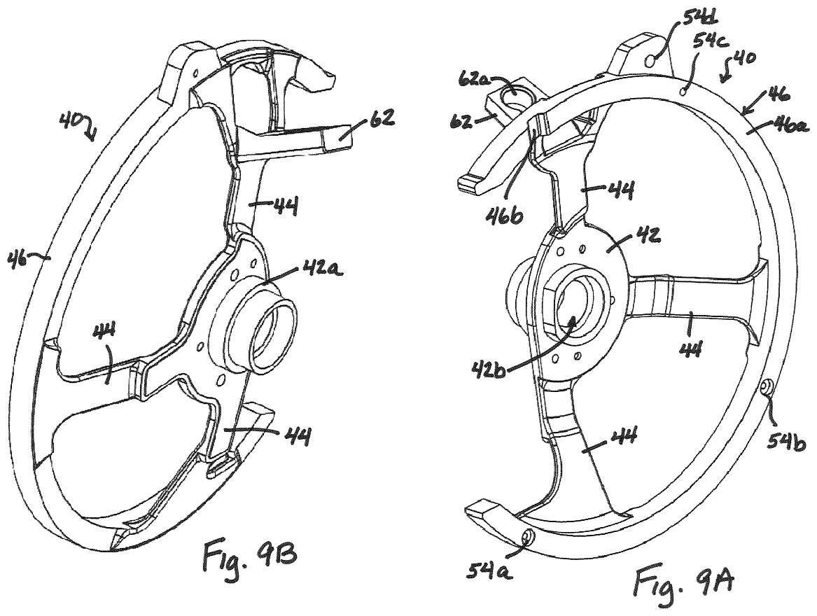

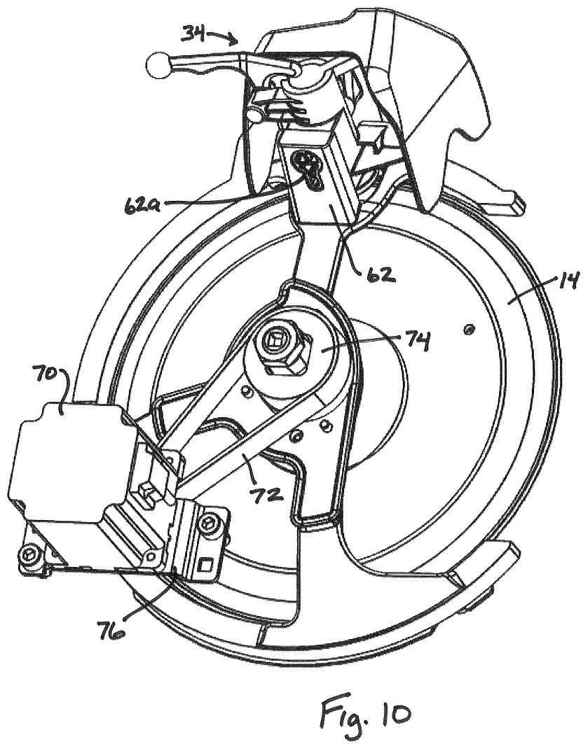

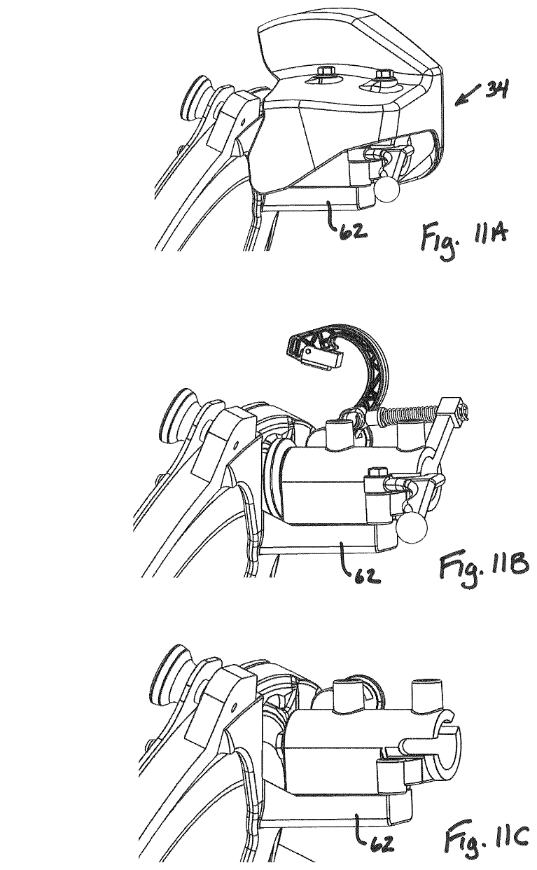

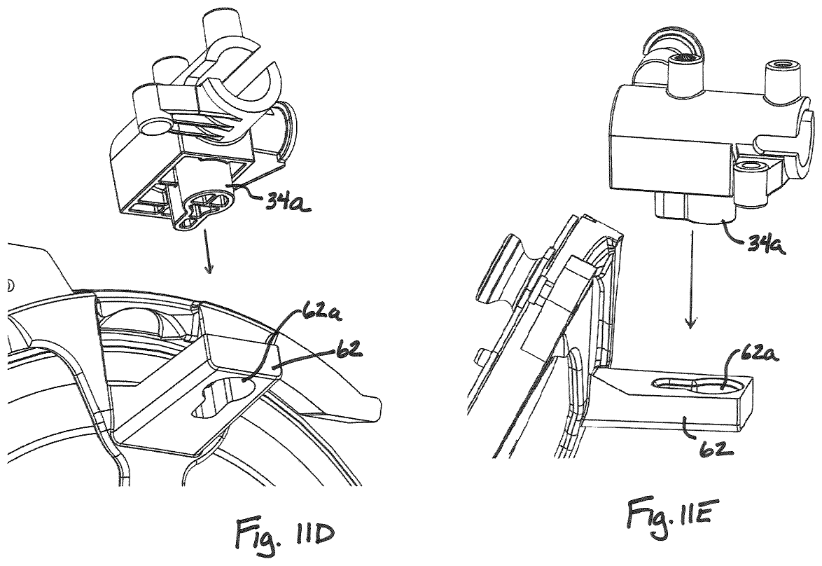

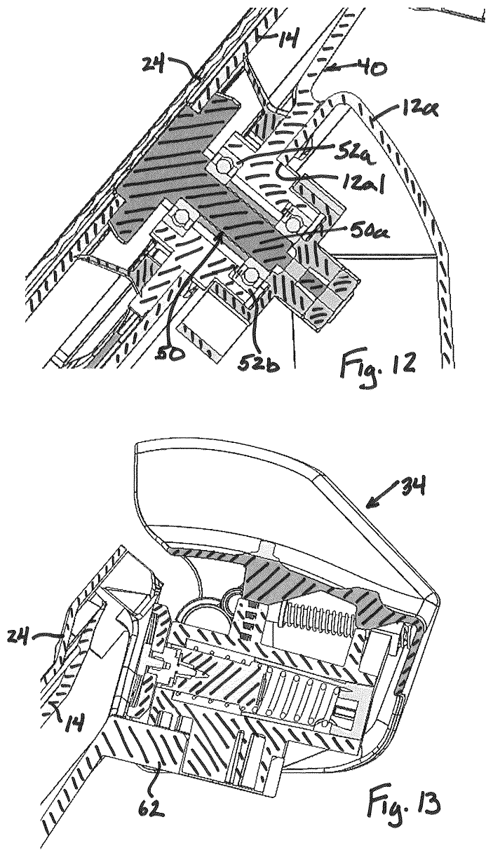

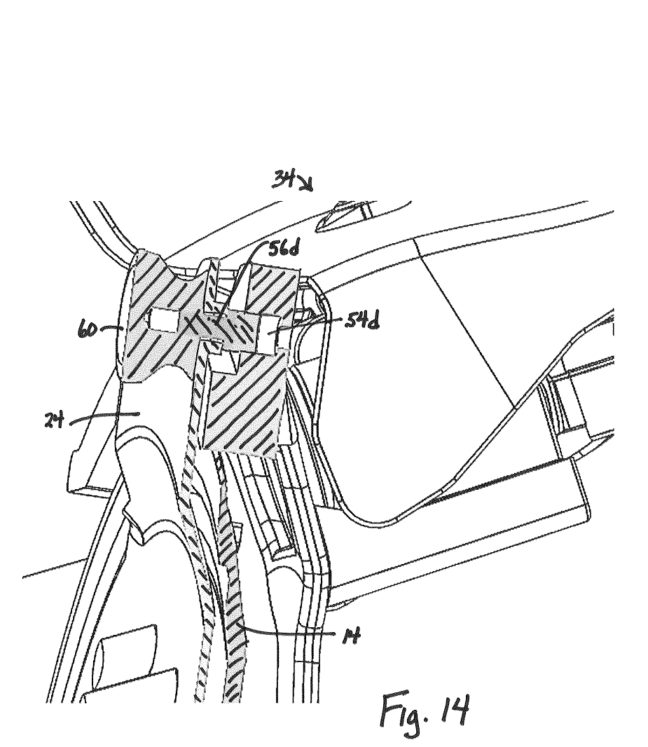

Referring to FIGS. 1-14, a food product slicer 10 includes a base 12 and a circular, motor-driven slicing knife 14 that is mounted to the base for rotation about an axis 16. Here, the base 12 includes an upper housing 12a and a lower housing 12b. The left side of FIG. 1, where the controls are located and an operator is located during slicing, is generally referred to as the front side of the slicer (which is where an operator stands for slicing), and the right side of FIG. 1 is generally referred to as the rear side of the slicer. A food product can be supported on a manually operable (or motor driven) food carriage 20 which moves the food product to be sliced past the cutting edge 14a of the rotating slicing knife 14. The food carriage 20 reciprocates from left to right relative to FIG. 1, along a linear path so that the lower end of the bulk food product slides along the surface of a gauge plate 22, is cut by the knife 14 and then slides along a knife cover plate 24. Food carriage 20 includes a tray mounted on a tray arm 26 that orients the food carriage tray at the appropriate angle (typically perpendicular) to the knife cutting-edge plane. The food carriage arm reciprocates in a slot 28 at a lower portion of an external housing 12a of the base 12. The carriage 20 can be moved manually (e.g., by a handle) and/or the carriage 20 may also be automatically driven (e.g., as by an internal motor 29 that drives a belt that is linked internally to the arm). A gauge plate system includes a rotatable knob 30 (connected to an opening in the base 12) that includes a grip part 30a and an internal cam part that is linked to the gauge plate 22 such that rotation of the knob 30 effects movement the gauge plate, relative to a plane of the knife edge 14a, to adjust slice thickness. Generally, the gauge plate 22 moves along an axis that runs parallel to the axis 16, such that the food product contact surface of the gauge plate 22 remains substantially parallel to the plane of the knife edge 14a. A knife sharpener assembly 34 is also mounted on the machine and can be manually operated to sharpen the knife edge 14a.

A single monolithic mount part 40 is provided to serve as both the part to which a drive shaft assembly for the knife 14 mounts and the part to which the knife cover plate 24 mounts. The knife itself mounts to part of the knife drive shaft 50. The configuration of the mount part 40 therefore defines the relative positioning of the knife cover plate 24 relative to the mount portion of the knife drive shaft 50, including in a direction along the knife axis 16, enabling a tight tolerance to be achieved between the relative position of the knife 14 and knife cover plate 24 after assembly. The monolithic part may be single piece unit, rather than multiple pieces connected together. In one example, the mount part 40 is formed of an aluminum material and is a single cast and machined part, which facilitates precise tolerancing during manufacture. Here, the mount part 40 also serves as the part to which the knife sharpener assembly 34 mounts, thereby assuring precise/tight tolerance in the position of the knife sharpener assembly 34 relative to the knife edge 14a.

The mount part 40 includes a central hub 42 from which spokes 44 run to a peripheral rim 46 that serves as a ring guard cover. The position of the mount part 40 on the slicer housing is defined by a rear hub part 42a that fits into a mount opening 12al on the upper housing 12a of the base 12. The position of a knife drive shaft 50 on the mount part 40 is defined by the opening 42b in the hub part 42, which defines internal annular seats that receive shaft bearing assemblies 52a and 52b, where the shaft segment 50a of knife drive shaft 50 is matingly received within the bearing assemblies 52a, 52b and the mount hub segment 50b seats axially against the bearing assembly 52a. The knife 14 then mounts to the knife mount hub 50b of the knife drive shaft 50 (e.g., via fasteners through aligned opening sets 50c and 14b). A cup-shaped seal member 45 is also mounted to the mount part 40 to seal against a rear surface of the knife 14.

The position of the knife cover plate 24 on the mount part 40 is defined by the axially facing rim surface 46a and mount openings 54a-54c thereon, which receive respective cover support/alignment pins 56a-56c, as well as mount opening 54d which receives a threaded support/alignment pin 56d. The knife cover plate 24 itself includes an opening 58c that aligns with and slides onto pin 56c, slots 58a-58b that engage onto pins 56a-56b, and an opening 58d that aligns with the threaded pin 56d. A removable knob 60 with a threaded opening threadedly engages onto the pin 56d to secure the cover plate 24 in place.

Thus, the axial positions (e.g., positions along a depth of the axis 16) of both the knife 14 and the knife cover plate are both tied to and defined by the configuration of the monolithic mount part 40.

The mount part 40 includes a knife mount platform 62 with a keyway opening 62a into which a mating key 34a of the sharpener assembly fits to define the position of the sharpener assembly 34, thereby defining a position of the sharpening stone(s) of the sharpener assembly relative to the knife edge. A recessed region 46b of the peripheral rim 46 enables the sharpening stone(s) to be moved into contact with the knife edge for knife sharpening.

The drive assembly for the knife is located internally of the upper housing 12a and includes a motor 70 that drives a belt 72 that turns a pulley 74 that in turn is connected to and rotates the drive shaft 50. The motor 70 is mounted to a plate 76 that in turn is secured by fasteners to a mount bracket 77 that is integrated with the upper housing 12a (e.g., monolithic with the upper housing 12a) and includes specified fastener positions 77a. The upper housing 12a also includes the opening 12al that fits over the rear hub part 42a to establish the position of the integrated bracket 77, and thereby establish the position of the drive components (the plate 76, the motor 70 and its drive shaft) mounted thereon. This configuration aids in achieving the desired and necessary spacing between the motor and motor shaft and the knife drive shaft 50, and also enables the knife drive assembly to be built as a sub-assembly (e.g., the motor 70, plate 76 and motor drive shaft formed as a sub-assembly that can be easily mounted to the mount bracket 77).

Thus, the system provides various advantages, including: fewer parts and lower cost, fewer assembly steps and with no adjustments (lower cost, easier manufacturing, easier to service), consistent tolerance/adjustment during its life, less customer down-time, and allowing both the knife shaft and knife motor parts to be built up as sub-assemblies, increasing the efficiency of machine production.

It is to be clearly understood that the above description is intended by way of illustration and example only and is not intended to be taken by way of limitation. Variations are possible.

1. A food product slicer, comprising:
a base;
a knife mounted for rotation about an axis relative to the base via a knife drive shaft;
a knife cover plate overlying regions of the knife;
a monolithic mount part that defines a first mount portion to which the knife drive shaft for the knife is mounted and a second mount portion to which the knife cover plate mounts, so as to establish a relative axial position between the knife and the knife cover plate.

2. The food product slicer of claim 1, further comprising:
a carriage assembly mounted to the base for reciprocal movement back and forth past a cutting edge of the knife; and
a gauge plate mounted for movement between a closed position that prevents slicing and multiple open positions that permit slicing at respective thicknesses.

3. The food product slicer of claim 1, wherein the first mount portion is a central hub of the monolithic mount part and the second mount portion is a peripheral rim of the monolithic mount part.

4. The food product slicer of claim 3, wherein a plurality of spokes extend from the central hub to the peripheral rim.

5. The food product slicer or claim 3, wherein a rear portion of the central hub engages into an opening in the base, wherein the central hub includes a through opening with at least one bearing seat in which a bearing assembly is positioned, wherein the knife drive shaft engages against the bearing assembly to define an axial position of the knife drive shaft, and the knife is fixed to a mount hub of the knife drive shaft to set an axial position of the knife.

6. The food product slicer of claim 5, wherein the peripheral rim includes an axially facing surface against which a portion of the knife cover plate seats to define an axial position of the knife cover plate.

7. The food product slicer of claim 3, further comprising:
a knife sharpener assembly;
wherein the monolithic mount part includes a third mount portion, that defines a mount station at which the knife sharpener assembly is mounted.

8. The food product slicer of claim 7, wherein the third mount portion comprises a mount platform that extends from one of the spokes and includes a keyway connection with the sharpener assembly.

9. The food product slicer of claim 5, wherein a knife drive motor is located relative to the knife drive shaft via an connection arrangement of the knife drive motor to the rear portion of the central hub.

10. The food product slicer of claim 9, wherein the connection arrangement comprises the opening in the base and a bracket integrated with the base and to which the knife drive motor is connected.

11. The food product slicer of claim 10, wherein the knife drive motor is mounted to a plate that has fastener openings, wherein the bracket includes fastener openings, and the fattener openings of the plate are aligned with the fastener openings of the bracket.

12. A food product slicer, comprising:
a base;
a knife mounted for rotation about an axis relative to the base via a knife drive shaft;
a knife cover plate overlying regions of the knife;
a monolithic mount part that defines:
a first mount portion to which the knife drive shaft for the knife is mounted;
a second mount portion to which the knife cover plate mounts; and
a third mount portion that defines a sharpener mount station.

13. The food product slicer of claim 12, wherein the first mount portion and the second mount portion define a relative axial position, along the axis, between the knife and the knife cover plate.

14. The food product slicer of claim 13, further comprising:
a carriage assembly mounted to the base for reciprocal movement back and forth past a cutting edge of the knife; and
a gauge plate mounted for movement between a closed position that prevents slicing and multiple open positions that permit slicing at respective thicknesses.

15. The food product slicer of claim 12, wherein the third mount portion defines a keyway for receiving a knife sharpening assembly.
